(19) United States
(12) Patent Application Publication
(10) Pub. No.: US 2013/0049272 A1
(43) Pub. Date: Feb. 28, 2013

(54) ELASTIC BEARING BUSH CONFIGURATION, ELASTIC BEARING, AND METHOD FOR PRODUCING THE ELASTIC BEARING BUSH CONFIGURATION

(71) Applicant: TRELLEBORG AUTOMOTIVE GERMANY GMBH, Breuberg (DE)

(72) Inventors: Peter MARX, Ruppach-Goldhausen (DE); Karsten GUETTLER, Steinen (DE)

(73) Assignee: TRELLEBORG AUTOMOTIVE GERMANY GMBH, Breuberg (DE)

(21) Appl. No.: 13/662,587

(22) Filed: Oct. 29, 2012

Related U.S. Application Data
(63) Continuation of application No. PCT/EP2011/056278, filed on Apr. 19, 2011.

(30) Foreign Application Priority Data
Apr. 28, 2010 (DE) 10 2010 018 536.1

(51) Int. Cl. F16F 7/00; B23P 11/02; B29C 41/20; B23P 11/00

(52) U.S. Cl. 267/141.2; 29/428; 29/525; 29/592

(57) ABSTRACT

An elastic bearing bush configuration is to be installed in a receptacle in particular for use in a suspension of a motor vehicle. The elastic bearing bush configuration contains an inner core, an outer sleeve, and an elastomer body connecting the inner core and the outer sleeve to each other. The outer sleeve is made of plastic. The elastic bearing bush configuration is characterized in that the outer sleeve has a press fit reinforcing element for fixing the outer sleeve in the receptacle by a force exerted directly on the receptacle by the press fit reinforcing element.

### CROSS-REFERENCE TO RELATED APPLICATION

This application is a continuation, under 35 U.S.C. §120, of copending international application No. PCT/EP2011/056278, filed Apr. 19, 2011, which designated the United States; this application also claims the priority, under 35 U.S.C. §119, of German patent application No. DE 10 2010 018 536.1, filed Apr. 28, 2010; the prior applications are herewith incorporated by reference in their entireties.

### BACKGROUND OF THE INVENTION

### Field of the Invention

The invention relates to an elastic bearing bush configuration for installation into a receptacle, in particular for use in a chassis of a motor vehicle, having an inner core, an outer sleeve and an elastomer body which connects the inner core and the outer sleeve to one another, wherein the outer sleeve is produced from plastic.

An elastic bearing bush configuration is described in published, non-prosecuted German patent application DE 103 54 727 A1 and contains an inner part, a housing and an elastomer layer which connects the inner part and the housing. Furthermore, the bearing bush has two retaining elements which are arranged in each case at the edge between the housing and the elastomer layer. The holding elements may be connected to the elastic intermediate layer by vulcanization.

German patent DE 44 28 870 C1 presents an elastic bearing bush which has an inner part, a metallic outer sleeve and an elastomer layer which connects the inner part and the outer sleeve to one another. A sliding insert is inserted between the outer sleeve and the elastomer layer. The sliding insert effects a relative rotation of the outer part with respect to the elastomer layer if a torque acting on the outer sleeve exceeds a certain value. Furthermore, the bearing bush has in each case one metallic support ring arranged at the edge, the support ring being connected to the elastomer layer. Here, the support rings accommodate axial forces and convert these into radial forces.

A further elastic bearing bush configuration is described in German patent DE 196 27 753 C2 and contains an inner part and an elastomer body which is composed of two rubber parts. Furthermore, two intermediate plates are arranged between the elastomer body and the inner part. A support ring is vulcanized onto the elastomer body axially on the outside.

Also known are elastic bearing bush configurations with outer sleeves composed of plastic. The embodiment offers the advantage that the outer sleeve is less susceptible to corrosion, and can be produced more cheaply, than a metallic embodiment. It has however been found that the plastic outer tubes have the significant disadvantage that, over the course of time, the interference fit in the receptacle deteriorates because the plastic tends to creep or settle. This disadvantage arises in particular if the bearing bush configuration is exposed to thermal influences, in particular high temperatures.

### SUMMARY OF THE INVENTION

The invention is based on the object of providing an elastic bearing bush configuration of the abovementioned type which is cheap to produce and which, over its entire service life, ensures that the interference fit is maintained at a high level even under the influence of high temperatures. It is also sought to specify an elastic bearing and a production method.

The elastic bearing bush configuration according to the invention contains an outer sleeve which is provided with an interference fit reinforcement element. The interference fit reinforcement element serves to fix the outer sleeve in the receptacle by a force exerted directly on the receptacle by the interference fit reinforcement element. As a result of the force exerted by the interference fit reinforcement element on the receptacle, the pressing-out force, that is to say the force required for pressing the bearing bush out of the receptacle in the axial direction, is increased. The bush can accordingly accommodate higher axial forces and/or oscillating forces without drifting out of the receptacle, and the pressing-out force can be maintained at the increased level for longer.

Furthermore, the increase in pressing-out force is influenced by the cross section of the interference fit reinforcement element and the yield strength thereof. A thicker cross section can allow a higher force to be exerted directly on the receptacle by the interference fit reinforcement element, and can thus increase the pressing-out forces in both axial directions of the bush.

The interference fit reinforcement element may, in preferred embodiments, be in the form of an inlay or insert. The outer sleeve with interference fit reinforcement element may furthermore be referred to as a hybrid outer tube. The interference fit reinforcement element preferably bears against the outer side of the outer sleeve.

In a preferred embodiment, the bearing bush configuration contains a plastic outer sleeve provided with the interference fit reinforcement element in the form of an open or closed metallic inlay or insert. The metallic inlay or insert, which is inserted into a cutout of the outer sleeve, is preloaded in the circumferential direction as the bush is pressed into the receptacle, resulting in an increase in the pressing-out force. As a result of the fact that a metal ring has a lower tendency to creep than a plastic ring, the pressing-out forces remain at approximately the same level over time and temperature. The increase in pressing-out force can be influenced by the cross section of the metal ring and the yield strength thereof. To produce an outer sleeve with the interference fit reinforcement element inserted in the cutout, the interference fit reinforcement element is pre-mounted onto the outside of the outer sleeve, and the bush with the interference fit reinforcement element situated in the cutout is then pressed into the receptacle.

In a further preferred embodiment of the bearing bush configuration, a metallic ring element with projecting claws is used as an interference fit reinforcement element. To produce the outer sleeve with the metallic ring element, the ring element is placed into a die mold. During the closure of the die mold, the latter presses the claws down such that the claws are under preload. The claw ring is subsequently encapsulated with plastic by insert molding, such that the plastic outer sleeve is formed simultaneously. The outer sleeve is subsequently removed from the mold, wherein the claws which are under preload stand up, because the plastic has not yet fully hardened. After hardening has taken place, during the further course of production, the claws are laid flat under preload as they are pressed into the receptacle. In the installed state, the claws press against the inner side of the receptacle owing to the preload, and thus exert a force directly on the inner side of the receptacle. When pressing-out forces are exerted, the claws bite into the receptacle, as a result of which the pressing-out force is increased. This variant is suitable in particular for bushes with a collar which prevents drifting-out in the other direction of the bush longitudinal direction.

The bush according to the invention is characterized in particular in that it is now possible to use plastic outer sleeves in installation locations with high pressing-out forces and high thermal loading, such as have hitherto been reserved only for metallic outer sleeves. The bush according to the invention is furthermore characterized by its low costs, its high capacity for being formed and shaped, its compressibility, its low weight and its corrosion resistance.

In a preferred embodiment, the interference fit reinforcement element is a ring-shaped element or a hollow cylindrical element. Furthermore, these elements can be configured in a continuous or discontinuous manner. Furthermore, the interference fit reinforcement element may be produced from a metallic material. Since the settling of an interference fit reinforcement element composed of metal is very much less pronounced than the settling of plastic, the metallic interference fit reinforcement element maintains the pressing-out force at approximately the same level over time and at different temperatures.

In a further preferred embodiment, the outer sleeve may have a cutout for receiving the interference fit reinforcement element. The cutout may be open to the outside in the radial direction and point in the direction of the receptacle. The cutout may, in a preferred embodiment, be rectangular in cross section. The embodiment offers the advantage that the outer sleeve can be connected in a positively locking manner to the interference fit reinforcement element, thus preventing a situation in which the bearing bush, without the interference fit reinforcement element, can drift out of the receptacle.

Furthermore, the interference fit reinforcement element may have an outer diameter larger than the inner diameter of the receptacle. This refers in particular to the state before the bush is pressed into the receptacle. In this way, the interference fit reinforcement element is preloaded in the circumferential direction as the bush is pressed into the receptacle. Here, the larger the diameter of the interference fit reinforcement element, the greater the force exerted directly on the receptacle by the interference fit reinforcement element. In this way, the interference fit of the bush in the receptacle is further increased, and an increased pressing-out force is required to press the bearing bush configuration out of the receptacle again.

In a further preferred embodiment, the interference fit reinforcement element has claws. The claws may project outward and be suitable for increasing the pressing-out force of the bearing bush configuration in at least one of the two axial directions. This embodiment is expedient in particular if the bush has a collar. As the bearing bush configuration is pressed into the receptacle, the claws are laid flat under preload, such that there is a slight increase in pressing-in force. During pressing-out, a form-locking connection is generated because the teeth bite into the receptacle, resulting in an increase of the pressing-out force.

Furthermore, the interference fit reinforcement element may be connected to the outer sleeve in a cohesive or force-locking manner. As a result of the force-locking action, the increase of the interference fit by the interference fit reinforcement element results in the increase of the pressing-out force of the bearing bush configuration. As a result of the cohesive action, it is not possible even in the uninstalled state for the interference fit reinforcement element and the outer sleeve to be detached from one another, and for one of the components to be lost. Furthermore, the interference fit reinforcement element may be connected to the outer sleeve in a cohesive manner by insert molding or molding-on.

The invention also encompasses an elastic bearing, in particular for use in a chassis of a motor vehicle. The elastic bearing contains a receptacle and the bearing bush configuration according to the invention, wherein the elastic bearing bush configuration is fixed in the receptacle by the interference fit reinforcement element. Here, the elastic bearing bush configuration is held fixed in the receptacle with increased pressing-out forces, as a result of which the bush can accommodate higher axial forces without drifting out of the receptacle. The elastic bearing is furthermore less sensitive to thermal influences than conventional elastic bearings with a plastic outer sleeve.

Furthermore, the invention contains a method for producing an elastic bearing bush configuration. The production method contains the provision of the outer sleeve composed of plastic and of the interference fit reinforcement element. The outer sleeve and the interference fit reinforcement element are connected such that, in the installed state of the bearing bush configuration in the receptacle, the interference fit reinforcement element exerts a force directly on the receptacle. The method permits the production of an elastic bearing bush with a plastic outer sleeve which approximately maintains the interference fit over the course of time even under increased thermal loading.

The connection of the outer sleeve and interference fit reinforcement element is preferably realized in a cohesive manner. In this way, the outer sleeve and interference fit reinforcement element are non-detachably connected to one another already in the uninstalled state. The cohesive connection is preferably realized by molding-on or insert molding. In another embodiment, the connection may be realized in a form-locking and/or force-locking manner. A form-locking connection is obtained in particular if the interference fit reinforcement element is configured as a ring element, insert or inlay, wherein the interference fit reinforcement element is at least partially accommodated in a cutout of the outer sleeve.

A form-locking connection is one that connects two elements together due to the shape of the elements themselves (e.g. a ball and socket), as opposed to a force-locking connection, which locks the elements together by force external to the elements (e.g. a screw).

Other features which are considered as characteristic for the invention are set forth in the appended claims.

Although the invention is illustrated and described herein as embodied in an elastic bearing bush configuration, an elastic bearing, and a method for producing the elastic bearing bush configuration, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a bearing bush configuration according to the invention;

FIG. 2 is a longitudinal sectional view through the bearing bush configuration installed into a receptacle;

FIG. 3 is a longitudinal sectional view through an outer sleeve of the bearing bush configuration, with an interference fit reinforcement element which has claws, installed into the receptacle;

FIG. 4 is a diagrammatic, perspective view showing a further view of the configuration as per FIG. 3; and

FIG. 5 is a diagrammatic, perspective detailed view of the interference fit reinforcement element with claws.

### DETAILED DESCRIPTION OF THE INVENTION

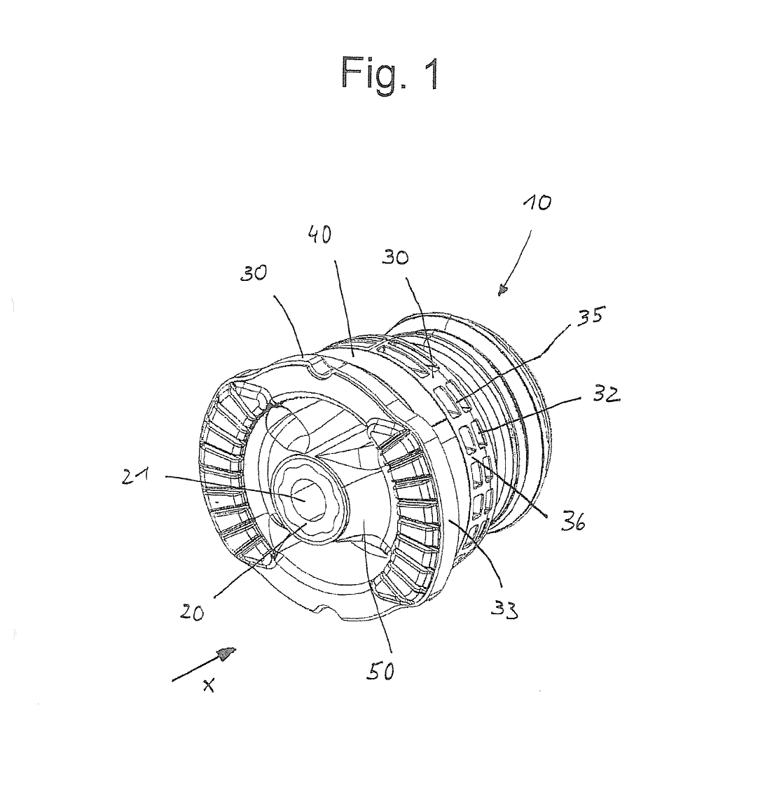

Referring now to the figures of the drawing in detail and first, particularly, to FIG. 1 thereof, there is shown an elastic bearing bush configuration 10 that contains an inner core 20, an outer sleeve 30 composed of plastic, and an elastomer body 50 which connects the inner core 20 and the outer sleeve 30 to one another. The elastomer body 50 is advantageously vulcanized onto the outer sleeve 30 and onto the inner core 20.

The bearing bush configuration 10 extends along an axial direction x, wherein the inner core 20, the outer sleeve 30 and an interference fit reinforcement element 40 are arranged coaxially. The inner core 20 has a bore 21 which likewise runs in the axial direction x.

On the outer side of the outer sleeve 30, the annular interference fit reinforcement element 40 is arranged in a cutout 31. The interference fit reinforcement element 40 is produced from a metallic material and is in the form of an insert or inlay.

Furthermore, the outer sleeve 30 may have a rib-like structure on its outer side. The rib-like structure serves for stiffening the outer sleeve 30 while simultaneously realizing a material saving, and is formed by a multiplicity of openings 32. The openings 32 are bordered by transverse ribs 35 and longitudinal ribs 36. As a result of the rib-like structure, uniformly small wall thicknesses are formed, which make it possible to keep the cycle times in the production process short. Furthermore, by this embodiment, it is possible to prevent the occurrence of shrinkage holes and other undesired cavities. The risk of distortion in the outer sleeve 30 can also be reduced. The outer sleeve 30 is preferably provided with a collar 33 which has a contact surface 34. The contact surface 34 is suitable for bearing against a support surface 61 of the receptacle 60.

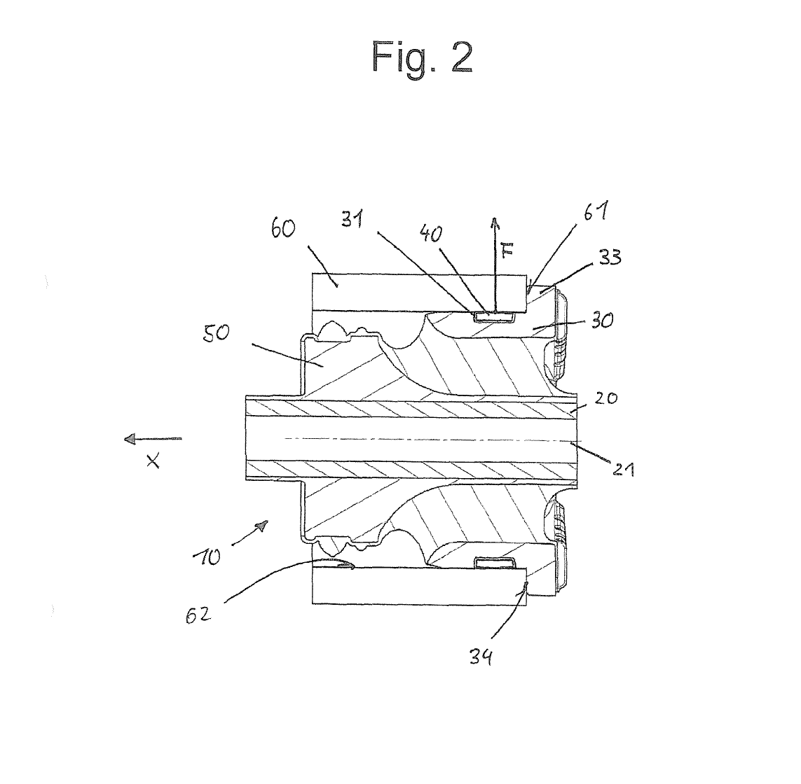

FIG. 2 shows a longitudinal section through the bearing bush configuration 10 as per FIG. 1 which has been installed into the receptacle 60. The receptacle 60 has an inner surface 62. The outer sleeve 30 has the cutout 31 which is formed so as to be open in the direction of the receptacle 60. The interference fit reinforcement element 40 is accommodated in the cutout 31. For the configuration of the outer sleeve 30 with the interference fit reinforcement element 40 inserted into the cutout 31, the interference fit reinforcement element 40 is pre-mounted onto the outside of the outer sleeve 30, and then the bearing bush configuration with the interference fit reinforcement element 40 situated in the cutout 31 is pressed into the receptacle 60. After the pressing-in process, the interference fit reinforcement element 40 bears against the receptacle 60 and exerts a force F on the receptacle 60 in the radial direction. The cutout 31 preferably has an approximately rectangular cross section. In this embodiment, the pressing-out force, that is to say the force required to press the bearing bush configuration 10 out of the receptacle 60 in the axial direction x, is increased. The collar 33 of the outer sleeve 30 has a diameter larger than the inner diameter of the receptacle 60 and forms the contact surface 34 which bears against the support surface 61 of the receptacle 60. Since the pressing-out force is increased in both directions, this embodiment is also suitable for an outer sleeve 30 without a collar 33.

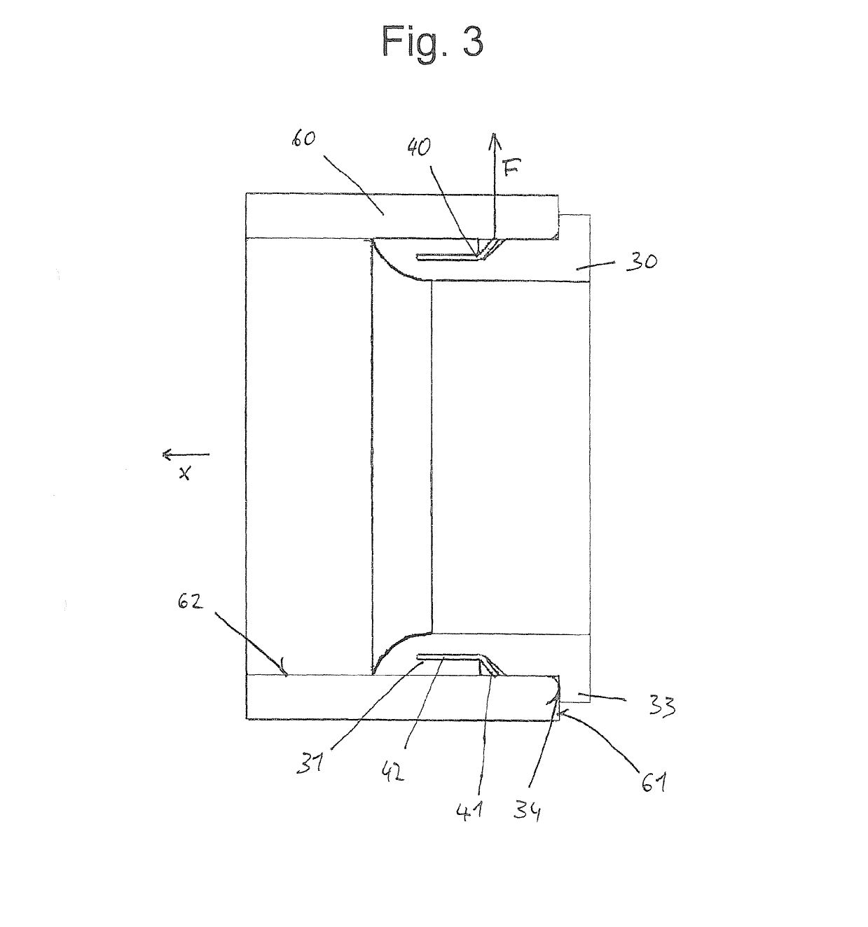

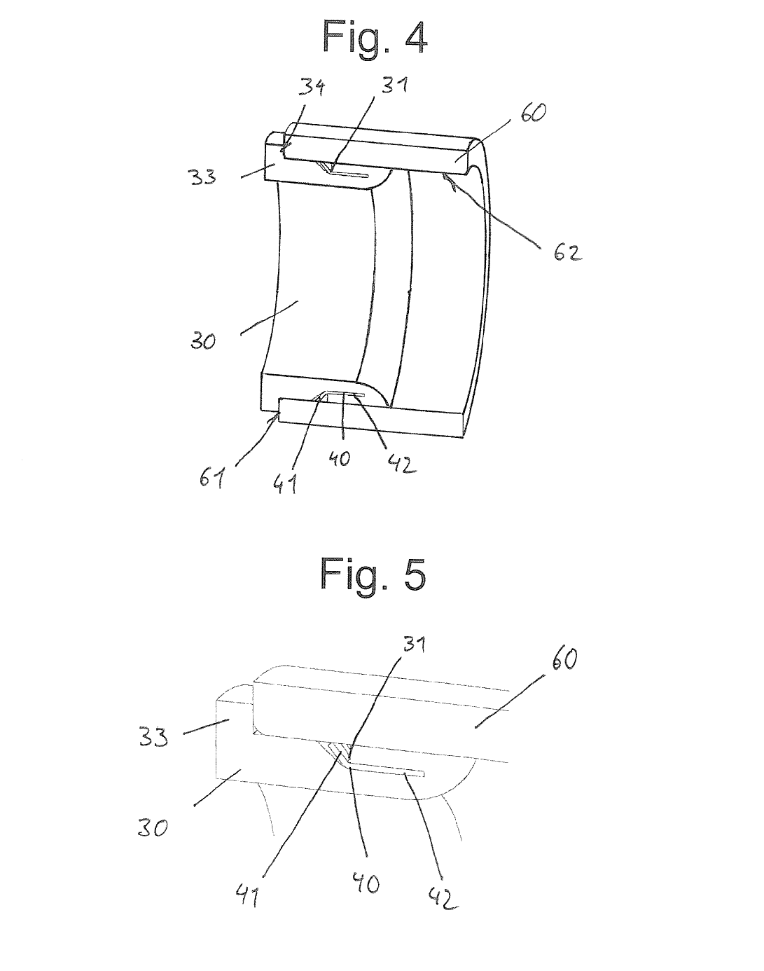

FIGS. 3 to 5 show different views of a further embodiment. To be able to illustrate in particular the interference fit reinforcement element 40 in detail, only the receptacle 60, the outer sleeve 30 and the interference fit reinforcement element 40 have been illustrated. In this embodiment, the interference fit reinforcement element 40 has an annular base 42 and a multiplicity of claws 41. The base 42 is fastened in the cutout 31 of the outer sleeve 30. Along the circumferential direction of the base 42, the multiplicity of claws 41 spaced apart equidistantly from one another in the circumferential direction project from the base 42. The interference fit reinforcement element 40 is thus connected cohesively to the outer sleeve 30, wherein the connection is realized by molding-on or partial insert molding of the base 42, as has already been explained further above. The claws 41 are preloaded in the radially outward direction toward the receptacle 60. As the bearing bush configuration 10 is pressed into the receptacle 60, the claws 41 are laid flat counter to their preload, so as to then exert a force F directly on the receptacle 60 in the installed state of the bush. In this exemplary embodiment, the claws 41 of the interference fit reinforcement element 40 thus bear against the inner side 62 of the receptacle 60 and exert a force F on the receptacle 60 in the radial direction. If a force now acts in the axial direction which encourages the bush to drift out, the claws 41 bite in, as a result of which the pressing-out force is increased. The claws 41 may also be in the form of teeth, prongs or hooks.

### LIST OF REFERENCE SYMBOLS

10 Bearing bush configuration
20 Inner core
21 Bore
30 Outer sleeve
31 Cutout
32 Opening
34 Contact surface
35 Transverse rib
36 Longitudinal rib
40 Interference fit reinforcement element
41 Claws
42 Base
50 Elastomer body
60 Receptacle
61 Support surface
62 Inner surface
x Axis
F Force

1. An elastic bearing bush configuration for installation into a receptacle, the elastic bearing bush configuration comprising:
an inner core;
an outer sleeve formed from plastic;
an elastomer body connecting said inner core and said outer sleeve to one another; and
an interference fit reinforcement element for fixing said outer sleeve in the receptacle by means of a force exerted directly on the receptacle by said interference fit reinforcement element.

2. The elastic bearing bush configuration according to claim 1, wherein said interference fit reinforcement element is a ring-shaped element or a hollow cylindrical element.

3. The elastic bearing bush configuration according to claim 1, wherein said outer sleeve has a cutout formed therein for receiving said interference fit reinforcement element.

4. The elastic bearing bush configuration according to claim 1, wherein said interference fit reinforcement element has an outer diameter larger than an inner diameter of the receptacle.

5. The elastic bearing bush configuration according to claim 1, wherein said interference fit reinforcement element has claws.

6. The elastic bearing bush configuration according to claim 1, wherein said interference fit reinforcement element is connected to said outer sleeve in a cohesive manner or a form-locking manner.

7. The elastic bearing bush configuration according to claim 6, wherein said interference fit reinforcement element is connected to said outer sleeve in a cohesive manner by insert molding.

8. The elastic bearing bush configuration according to claim 1, wherein the elastic bearing bush configuration is configured for use in a chassis of a motor vehicle.

9. The elastic bearing bush configuration according to claim 2, wherein said ring-shaped element or said hollow cylindrical element is produced from a metallic material.

10. An elastic bearing, comprising:
a receptacle;
an elastic bearing bush configuration installed in said receptacle, said elastic bearing bush configuration containing:
an inner core;
an outer sleeve formed from plastic;
an elastomer body connecting said inner core and said outer sleeve to one another; and
an interference fit reinforcement element fixing said outer sleeve in said receptacle by means of a force exerted directly on said receptacle by said interference fit reinforcement element.

11. The elastic bearing according to claim 10, wherein the elastic bearing is configured for use in a chassis of a motor vehicle.

12. A method for producing an elastic bearing bush configuration, which comprises the steps of:
providing an outer sleeve composed of plastic;
providing an interference fit reinforcement element; and
connecting the outer sleeve and the interference fit reinforcement element such way that, in an installed state of the elastic bearing bush configuration in a receptacle, the interference fit reinforcement element exerts a force directly on the receptacle.

13. The method according to claim 12, wherein a connection of the interference fit reinforcement element to the outer sleeve is realized in a cohesive manner.

14. The method according to claim 12, wherein a connection of the interference fit reinforcement element to the outer sleeve is realized in at least one of a form-locking manner or a force-locking manner.

15. The method according to claim 12, wherein a connection of the interference fit reinforcement element to the outer sleeve is realized by one of molding-on or insert molding.

16. The method according to claim 12, wherein a connection of the interference fit reinforcement element to the outer sleeve is realized in an integral manner.

17. The method according to claim 12, wherein a connection of the interference fit reinforcement element to the outer sleeve is realized in a materially connected manner.
